(19) United States
(12) Patent Application Publication
(10) Pub. No.: US 2009/0116964 A1
(43) Pub. Date: May 7, 2009

(54) Turbine rotor and method for producing the rotor

(75) Inventor: Hans-Egon Brock, Oberhausen (DE)

Correspondence Address: COHEN, PONTANI, LIEBERMAN & PAVANE LLP, 551 FIFTH AVENUE, SUITE 1210, NEW YORK, NY, 10176, US

(73) Assignee: MAN TURBO AG, Oberhausen (DE)

(21) Appl. No.: 12/005,525

(22) Filed: Dec. 27, 2007

Related U.S. Application Data
(63) Continuation-in-part of application No. PCT/EP2006/006218, filed on Jun. 27, 2006.

(30) Foreign Application Priority Data
Jun. 28, 2005 (DE) 10 2005 030 516.4

(51) Int. Cl. F01D 5/30; F01D 5/22; B23P 15/04

(52) U.S. Cl. 416/179; 416/219 R; 29/889

(57) ABSTRACT

A turbine rotor has a row of turbine blades associated with a circumferential groove in a disk, each turbine blade having foot received in the groove, a blade profile above the foot, and a shroud plate above the profile. Each blade foot and each shroud plate have end surfaces and side surfaces which form a rhomboid, the end surfaces of each shroud plate tapering toward each other along respective radii and abutting the end surfaces of adjacent shroud plates to form a closed ring. The blade profiles are torsionally stressed by applying a force to each plate in a direction parallel to the axis of the disk, thereby twisting the cover plates through an angle alpha so that the side surfaces of adjacent cover plates are circumferentially aligned in a plane perpendicular to the longitudinal axis. This force is maintained by clamping devices applied to the combs of adjacent blades.

### CROSS REFERENCE TO RELATED APPLICATION

This application is a Continuation-in-Part of PCT Application No. PCT/EP2006/006218 filed 27 Jun. 2006, which claims priority from DE 10 2005 030 516.4 filed 28 Jun. 2005.

### FIELD OF THE INVENTION

The invention pertains to a turbine rotor and to a method for producing a rotor of the type having a row of turbine blades associated with each groove in a rotor disk, wherein each turbine blade has a blade foot received in the groove, a blade profile above the foot, and a shroud plate above the profile, each blade foot and each shroud plate having end surfaces and side surfaces which form a rhomboid, the end surfaces of each shroud plate tapering toward each other along respective radii and abutting the end surfaces of adjacent shroud plates so that the shroud plates form a closed ring.

### DESCRIPTION OF THE RELATED ART

Vibrations in the blades of steam or gas turbines lead to the formation of cracks in the blades, and after enough time a blade can break off, causing severe damage to the turbine. So that problem-free operation of the turbine can be guaranteed, blade vibrations must be reduced by suitable design measures. To damp the vibrations of rotor blades in the medium-pressure and low-pressure ranges of steam turbines, the following solutions, among others, are used:

In the case of relatively large final-stage blades in the low-pressure range of the turbine, a retaining wire passing circumferentially through bores in the profile area damps the vibrations. This type of vibration damping is usually used for blades without shroud plates.

In the case of rotor blades which are subjected to only low circumferential velocities, a shroud band is riveted segment-by-segment to the ends of the profiles of the blades installed in the rotor. This design was frequently used in older turbines. In the case of turbines with high circumferential velocities, the strength of these riveted joints is insufficient. The riveted design cannot be used here.

In the medium-pressure and also increasingly in the low-pressure ranges of turbines, shroud-plate rotor blades, which combine good strength with high efficiency, are used almost exclusively today. The blades and the cover band (shroud plate) belonging to them in this design form a one-piece unit. The disadvantage of the low strength of the riveted Joint is avoided here, because the blade and the shroud plate are an integral part of each other. After the rotor blades have been installed in the turbine rotor, the shroud plates of the individual blades form a ring. The vibration damping occurs in the ring at the contact surfaces between the shroud plates of the individual blades.

The known design suffers from the following weaknesses, however. Because of the manufacturing tolerances to which each blade is subject and which are different in each case, it is impossible in practice—in the case of a stage with 70 rotor blades, for example—to install the blades in such a way that there is no play between them. Other reasons for this difficulty include the powerful centrifugal forces which act on the blades and the thermal expansion which acts on each individual section of the rotor blade during operation of the turbine. The centrifugal forces and the thermal expansion have the effect of causing the feet of the blades in the rotor to shift outward slightly. The shroud plates of the blades, furthermore, move outward in the longitudinal direction as a result of the elongation of the blade profile. Because the base surface and the shroud plate surface of each blade form a wedge, the outward-shifting movements of the blades just described leads to the formation of a gap between the shroud plate surfaces of the individual blades. As a result of this gap, the vibrations are no longer damped as desired. To avoid the disadvantages caused by the formation of gaps as described above, the following known solutions are available:

In U.S. Pat. No. 7,104,758, a turbine rotor is described, in which vibration dampers are installed at the contact surfaces between the shroud plates. While the turbine is operating, the vibration dampers are pushed outward by centrifugal force and thus create a connection between the shroud plates. Any gap which may be present is bridged by the vibration damper, as a result of which the vibrations are damped.

JP 2003097216 A1 describes an application in which the blade profile is bent slightly in the longitudinal direction by centrifugal force. As a result of this bending, an opposing movement is generated in the shroud plate. This movement compensates for any gap which may be present and thus guarantees the damping of the vibrations.

According to U.S. Pat. No. 4,840,539 B2, the shroud plates of the turbine blades are designed in the form of a “V”. After the blades are installed in the rotor, the shroud plates touch each other on only one side in the radial direction. To damp vibrations, torsional stress is produced by twisting the blade profile. On the free side of the shroud plate, there is an additional axial contact surface for vibration damping.

U.S. Pat. No. 6,568,908 B2 describes an application in which centrifugal force generates an opposing twisting movement at the contact surfaces of the shroud plate as a result of the elongation of the blade profile; this twisting movement is used to damp vibrations. The contact surfaces on the shroud plates are profiled with radii. A similar application is also used in practice by several turbine manufacturers. Here, too, the twisting of the blade profile caused by centrifugal force is used to damp the vibrations. The shroud plates are designed here in the form of a “Z”, with only their middle sections contacting each other during operation of the turbine. The two applications can be used only in the case of blades with a conical and simultaneously twisted blade profile, because only here will the shroud plates twist as desired as a result of centrifugal force.

The present invention is based on a known application which several turbine manufacturers have used for many years for rhomboidal rotor blades with shroud plates; it is also described in JP 5098906 A1. Here the outer surface of the blade foot and the outer surface of the shroud plate are at the same angle to the center of the rotor. A spacing surface on the shroud plate is made oversized with respect to the theoretically correct spacing. The idea is that, when the blades are installed in the rotor, the shroud plates will twist with respect to the blade feet as a result of the spacing oversize until the theoretically correct spacing is restored. The shroud plates are twisted when they are installed in the rotor under the effect of the radial force used to drive the blades in. The blade feet must be mounted without any gaps between them. As a result of the friction at the contact surfaces between the blade base and the rotor, the blades are supposed to assume their intended radial position and simultaneously absorb the opposing forces of the twisting of the shroud plates. In addition, a device is used to spread the last gap between the blades radially during installation of the locking blade. The twisting of the shroud plate generates torsional stress in the blade profile, which, through its spring-like action, prevents the formation of gaps between the shroud plates during operation of the turbine, and this in turn guarantees that the task of vibration damping will be fulfilled.

The process known from JP 5098906 A1 suffers from the following disadvantages. The friction between the blade foot and the rotor cannot reliably generate and maintain the necessary radial force to withstand the twisting of the shroud plates upon installation of the blades—this depends on the ratio between the width of the profile to its length or thickness. Because all of the installed blade shroud plates must be twisted in the same direction, the forces necessary for twisting are additive. The first blade to be installed occupies the desired radial position in the rotor. The following blades, however, because of the spacing oversize of the shroud plates and the insufficient degree of twisting, deviate increasingly from the required radial positioning. As a result of the deviation from the required radial positioning, only one side of the blade support shoulders rests on the rotor groove, and increasingly wider, wedge-shaped gaps form between the blade feet.

The force required to twist the shroud plates is introduced from the blade foot and proceeds via the blade profile into the shroud plate. Because of the length of the path along which this force is transmitted and because of the uncertain amount of friction actually present, the known process cannot be implemented reliably. In addition, when the force is being transmitted from the foot to the shroud, the blade profiles are bent in the longitudinal direction. The spacing surfaces at the blade foot and at the shroud plate must be free to permit the installation of the next blade. A device for holding and absorbing the opposing forces generated by the twisting cannot be used on these surfaces.

The device used to produce the necessary shroud plate gap above the locking opening for installation of the last blade must accordingly fulfill the following requirements: The last installed blade must be pushed by its shroud plate into the required radial position without causing a change in the position of the first blade. Decreasing from the last blade to the second installed blade, the force generated by the known device must flow seamlessly in the radial direction through the entire stage and twist all of the shroud plates to generate the torsional stress. Any gaps present between the blade feet must be compensated. The blades may not be damaged by uncontrolled forces. The device may not intrude into the space required to install the locking blade. These requirements on the known device can be fulfilled, if at all, only with great difficulty and at very high cost. It must also be kept in mind that, as a result of the rhomboidal angle of the shroud plate, forces introduced in the radial direction leave the stage again after only a few blades.

### SUMMARY OF THE INVENTION

The invention is based on the task of designing a rotor of the general type in question in such a way and to provide a process and a device of such a type that, after installation of the blades in the rotor, it is possible to produce the torsional stress required to damp the vibrations of the rhomboidal rotor blades easily, with a high degree of reliability in terms of the process technology involved, and at low cost.

According to the invention, the blade profiles are torsionally stressed by twisting the cover plates through an angle alpha so that the side surfaces of adjacent cover plates are circumferentially aligned in a plane perpendicular to the longitudinal axis.

During assembly, each blade foot is inserted into one of the grooves so that the end surfaces of each blade foot abut the end surfaces of adjacent blade feet and the end surfaces of each shroud plate abut the end surfaces of adjacent shroud plates, the side surfaces of each shroud plate forming an angle alpha with the radial plane. A force acting in the direction of the longitudinal axis is then applied to each shroud plate to twist the shroud plate through the angle alpha so that the blades are torsionally stressed and the side surfaces of adjacent cover plates are circumferentially aligned in a plane perpendicular to the longitudinal axis. This force is maintained on the blades until a complete circumferential row of blades has been inserted into the groove and the cover plates form a closed ring.

The force is preferably maintained by clamping devices which each have a longitudinal channel bounded by two sides, one of the sides having a pair of threaded bores oriented transversely to the longitudinal channel, each of the bores receiving a clamping screw. The channel is placed over the combs of two adjacent shroud plates and the device is centered between the two shroud plates, followed by tightening the clamping screws against respective shroud plates to twist at least one of the shroud plates through the angle alpha.

The invention can be applied easily and with great technical reliability as a result of the following points. When the rotor is being designed, the calculation or design department will determine the torsion angle of the blades and enter it on the drawing of the shroud plate of the blade. The side surfaces or plan surfaces of the shroud plates are fabricated with this angle on all of the blades.

The shroud plates of all the blades are fabricated with the angle indicated in the drawing. After installation in the rotor, each blade is then twisted by means of a clamping device by application of a predetermined, minimally calculated axial force and held reliably in this position throughout the installation process.

The blades can be twisted easily and reliably upon assembly. The force needed to twist the shroud plates is generated positively and directly on the shroud plates and also positively maintained on the shroud plates during installation. The application of the invention is thus independent of the friction generated between the contact surfaces of the blades in the rotor.

After the installation of each blade, its radial position in the rotor can be checked. The gap for installing the locking blade is present immediately. The installation of the locking blade is not impeded by the presence of the clamping devices. Because the clamping devices are simple to use and inexpensive, the invention can be implemented at low cost. All of the previously described disadvantages of the process known from JP 5098906 A1, especially the danger that the blades could be damaged when they are twisted as a result of the uncontrolled introduction of radial force, are avoided.

### BRIEF DESCRIPTION OF THE DRAWINGS

FIG. 1 shows a front view of a rotor blade;

FIG. 2 shows a side view of FIG. 1, looking in the direction A of FIG. 3;

FIG. 3 shows a plan view of FIG. 1;

FIG. 4 shows an axial cross section of a rotor blade after installation in the rotor;

FIG. 5 shows a plan view of the shroud plates of three rotor blades installed in the rotor before they are twisted;

FIG. 6 shows a plan view of the shroud plates of three rotor blades installed in the rotor after they are twisted;

FIG. 7 shows a front view of the clamping device as it is being used;

FIG. 8 shows a side view of the clamping device as it is being used;

FIG. 9 shows a plan view of the clamping device as it is being used;

FIG. 10 shows an example of an alternative use of a retaining wire instead of a clamping device;

FIG. 11 shows an example of a clamping device extending over the entire width of the shroud plate;

FIG. 12 shows an example with a retaining groove next to the width of the shroud plate;

FIG. 13 shows a plan view of the contours of a shroud plate before and after twisting;

FIG. 14 shows the way in which the decrease in spacing functions on an enlarged scale;

FIG. 15 shows a concrete example of the triangles and formulas used to calculate the torsion angle Alpha; FIG. 16A is an end view of the locking blade foot and the blade lock in the area of the loading channel; and FIG. 16B is a plan view of the arrangement of FIG. 16A.

### DETAILED DESCRIPTION OF THE PREFERRED EMBODIMENT

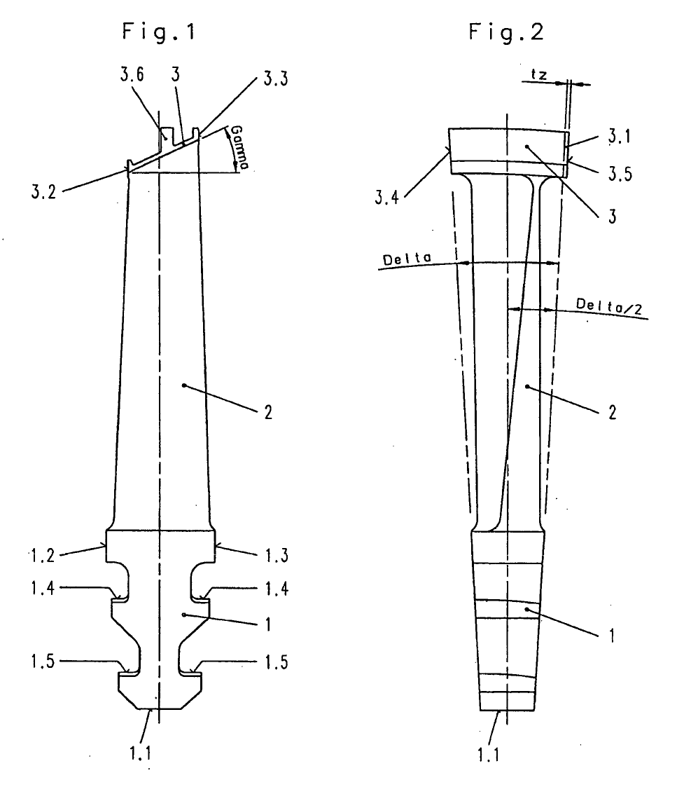

The blade of a turbine consists of a blade foot 1, which has a tapered shape and, in the case shown here, is designed as a double hammer head with support shoulders 1.4 and 1.5, lateral surfaces 1.2 and 1.3, and a base surface 1.1. From the foot plate of the blade, a blade profile 2 proceeds upward with a taper and also with a twist. A shroud plate 3 with an expansion bevel, which forms an angle Gamma with the horizontal (FIG. 1), is provided at the top end of the blade profile 2. The blade foot 1 and the shroud plate 3 have the geometric form of a rhomboid or parallelogram. The shroud plate 3 has two side or plan surfaces 3.2, 3.3 and two end or spacing surfaces 3.4 and 3.5. The plate is also provided with a sealing comb 3.6. In the installed state, the side or plan surfaces 3.2, 3.3 are aligned with each other in the circumferential direction of the rotor 4, whereas the end or spacing surfaces 3.4, 3.5 are at an angle to the longitudinal axis of the rotor 4 (rotor center RM).

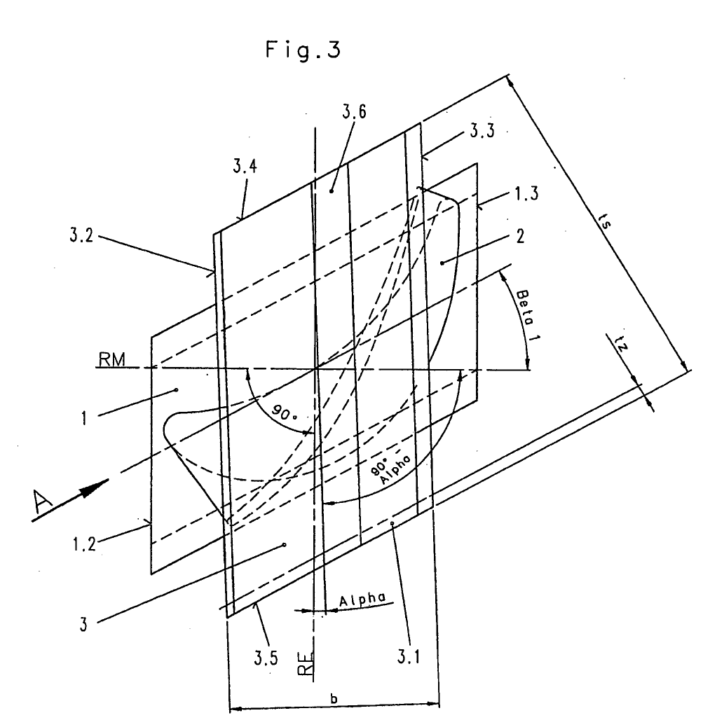

The shroud plate 3 and the blade foot 1 in FIG. 2 are designed with the same taper on both sides, which is characterized by the angle Delta. The one spacing surface 3.4 of the shroud plate 3 lies on the same plane as the slanted foot surface of the blade foot 1. The other spacing surface 3.5 is provided with a parallel spacing oversize 3.1 with the dimension “tz”. As can be seen in FIG. 3, the two spacing surfaces 3.4 and 3.5 of the shroud plate 3 and the associated spacing surfaces on the blade foot 1 are at a rhomboidal angle Beta 1 to the longitudinal axis RM of the rotor 4. The shroud plate 3 has a length with the dimension “ts”. The dimension “ts”, which is defined by the two spacing surfaces 3.4 and 3.5, is based on the maximum diameter of the shroud plate 3 and is shown in simplified form in FIG. 3 without consideration of the expansion bevel.

The invention is also applicable to blades with other foot shapes such as those with a single hammer head and those with a one-sided or asymmetric taper as well as to shroud plates 3 of different designs such as those without an expansion bevel and those with spacing oversizes 3.1 on both sides.

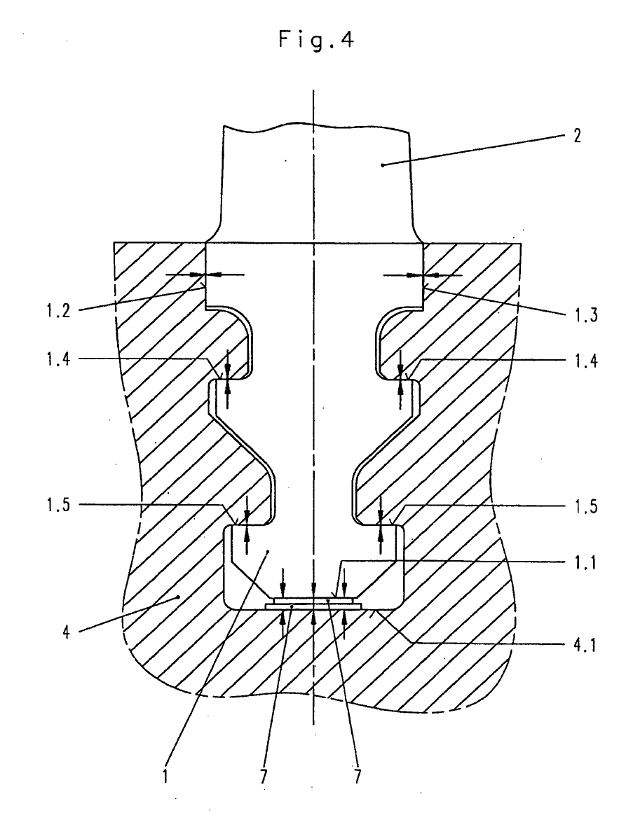

In the case illustrated in FIG. 4, the blade feet 1 are inserted into a radial groove extending around the circumference of the rotor 4 of the turbine, the groove being designed to conform to the shape of the blade foot 1. The tapered spacing surfaces of the blade feet 1 rest against each other and thus fill up the groove. The two lateral surfaces 1.2 and 1.3 define the width of the foot by which the blade is guided in the rotor 4. The bottom surface 1.1 of the blade foot 1 is installed on the base of the groove 4.1 in the rotor 4 without play by the use of shim strips 7. The support shoulders 1.4 and 1.5 of the blade foot 1 rest with slight pretension against the rotor 4. The support shoulders 1.4 and 1.5 absorb the centrifugal forces and transmit them to the rotor.

According to a feature of the invention, the blade is fabricated so that it can be inserted into the groove in the rotor 4 in such a way that the plan surfaces 3.2 and 3.3 of the shroud plate 3 and the plan surfaces of the sealing comb 3.6 do not lie in the radial plane RE but rather deviate by a twist angle Alpha from the radial plane RE to form an angle of 90° minus Alpha to the longitudinal axis RM of the rotor 4, as shown in FIG. 3. To make it easier to understand this aspect, the twist angle Alpha is shown enlarged in all the figures.

After a blade has been inserted into the groove of the rotor 4, each individual blade is twisted. According to a feature of the invention, the force F1, F2 required to twist the blade is applied positively in the axial direction directly to the shroud plate 3. The introduced force F1, F2 is also maintained positively, directly on the shroud plates 3.

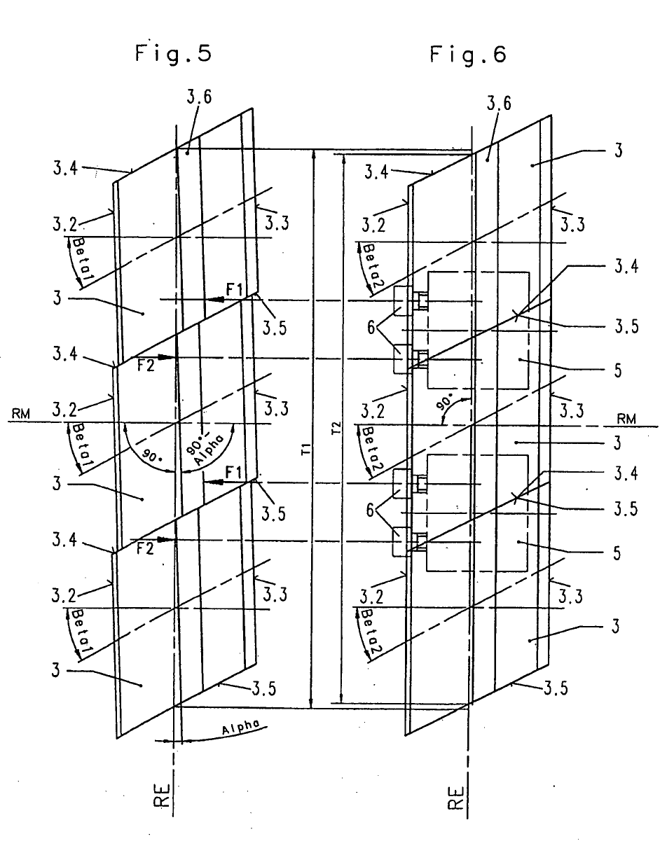

The way in which the invention works can be derived from FIGS. 5 and 6. FIG. 5 shows a plan view of three shroud plates 3 before they are twisted. The spacing surfaces 3.4 and 3.5 rest against each other, and, because of the angle Alpha, the sides with the oblique angles project beyond the plan surfaces 3.2 and 3.3 of the shroud plates 3 of the adjacent blades. The same also applies to the middle sealing comb 3.6. For an angle of 90° to the longitudinal axis RM of the rotor 4, the total spacing T1 is obtained for the shroud plates 3 in the radial plane RE.

FIG. 6 shows a plan view of the three shroud plates 3 after they have been twisted. By means of the clamping devices consisting of U-shaped blocks 5 and clamping screws 6, to be described later, the sealing comb 3.6 and simultaneously the plan surfaces 3.2 and 3.3 are brought into alignment. The clamping devices generate an opposite twist on all three shroud plates 3. As a result of the twisting produced by the clamping devices, the original rhomboid angle Beta 1 of the shroud plate 3 changes (FIG. 5) to a new rhomboid angle Beta 2. As a result of the change in the angle, the total spacing T1 of FIG. 5 is reduced to T2 in FIG. 6:

The invention cannot be applied to rotor blades with an angle Beta 1 equal to 0°. In this case, the shroud plate has the form of a rectangle. The spacing reaches the minimum value for “ts” in FIG. 3. When the shroud plate is twisted, “ts” increases. The decrease—as desired in accordance with the invention—which occurs in the effective shroud plate spacing in the radial plane RE when the plates are twisted does not occur in the case of rectangles.

As can be seen in FIG. 4, the twisting of the shroud plates 3 is blocked by the blade feet 1 held in the groove in the rotor 4, specifically by the foot width between the lateral surfaces 1.2 and 1.3, which fits widthwise precisely in the groove. The blade profile 2 itself, however, does twist, the degree of twist decreasing from the shroud plate 3 to the blade foot 1. The twisting of the blade profile 2 generates torsional stress in the elastic range, which remains stored as if in a spring. After the locking blade has been installed and the entire row of blades is complete and all of the clamping devices have been removed, the shroud plates 3 of the ring of blades form a closed ring, in which the shroud plates 3 block each other. Because of the spacing oversize 3.1 on all the shroud plates 3, these plates 3 can no longer twist back into their original positions (see FIG. 5). The torsional stress remains stored in the blade profiles 2 and can thus fulfill the task imposed on them, namely, to compensate for any gaps which may occur between the shroud plates 3 during operation of the turbine.

Before the shroud plates 3 are twisted, the twist angle Alpha with which the shroud plates are already fabricated has the effect of producing an offset at the end or spacing surfaces 3.4, 3.5 of the shroud plates 3 with respect to the adjacent shroud plates 3 when the blades are installed without force in the rotor 4 (FIG. 5). The size of the offset determines the degree to which the clamping devices, to be described later, will twist the shroud plates 3.

The twist angle Alpha is composed of the theoretical twist angle required for the increased spacing plus a loss allowance. The loss allowance is intended to compensate for losses which result from changes in position at the blade foot 1 on installation in the rotor 4 as a result of play which may exist in the guide width, from the efficiency of the clamping device, from the spring-back of the blades, and from the formation of gaps at the spacing surfaces of the shroud plates during installation of the blades. In addition, it is necessary to produce a gap of least 1 mm in the last shroud plate spacing to ensure that the locking blade can be installed without force. The size of the loss allowance added to the theoretical twist angle required for the increased spacing is determined by the actual design of the rotor blade and of the rotor 4. It is an empirical value and can only be estimated during the first application. To ensure unobstructed installation of the blades, it is advisable to make the allowance greater than necessary.

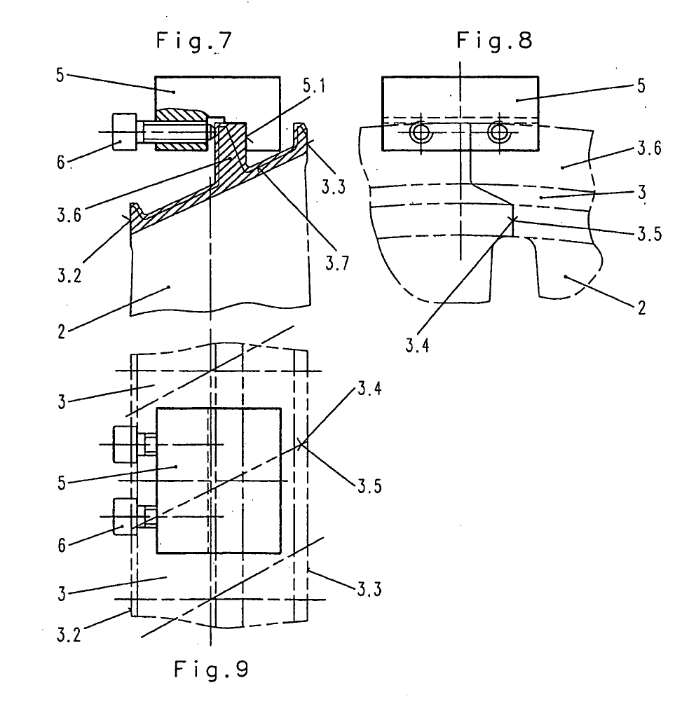

FIGS. 7-9 show a simple clamping device for twisting the shroud plates 3. This clamping device consists of a U-shaped block 5 with a longitudinal groove 5.1. One of the sides of the block 5 is provided with two threaded bores, each of which holds a clamping screw 6. The longitudinal groove 5.1 of the block 5 is placed with play on the sealing combs 3.6 of two adjacent shroud plates 3 and centered with respect to the two spacing surfaces 3.4 and 3.5 of the two plates. The two clamping screws 6 are then tightened against the two adjacent blades, namely, the blade just inserted into the groove in the rotor 4 and the blade inserted just before that. The clamping screws 6 twist the two shroud plates by the angle Alpha and thus bring the sealing combs 3.6 and the plan surfaces 3.2 and 3.3 into alignment. After the last blade in the row has been inserted and twisted with respect to the adjacent blade, the clamping device blocks 5 are removed. The shroud plate 3 is premachined with a machining allowance to facilitate installation into the rotor 4. The finished contour 3.7 is turned after installation of the blades.

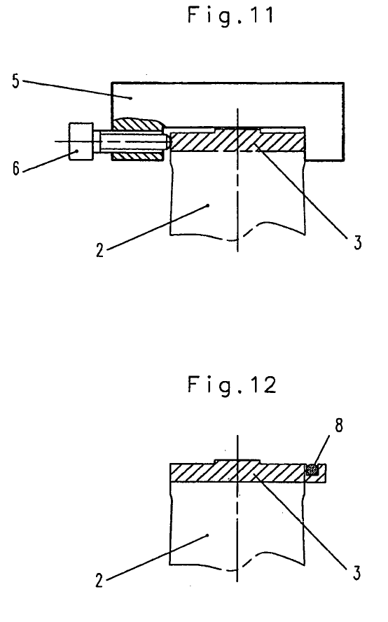

Depending on the shape and size of the shroud plate 3, a similar clamping device can also be used alternatively on the web of the plan surface 3.3 or placed across the entire width of the shroud plate (FIG. 11).

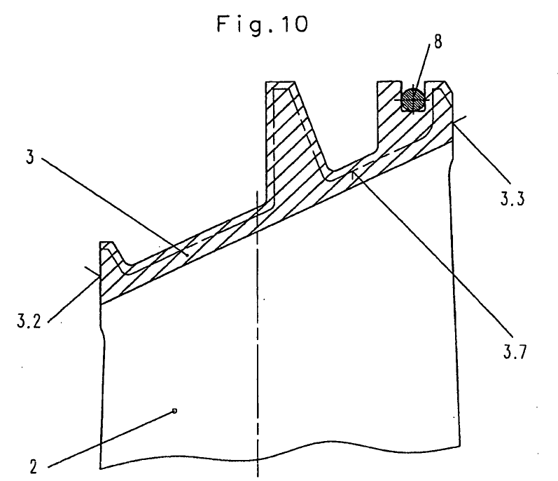

As an alternative to the previously described clamping device, it is also possible, as shown in FIG. 10, to machine an auxiliary groove into the outside diameter of the shroud plate 3 to hold a retaining wire 8. The shroud plates 3 are twisted by hand into the desired position with a suitable tool such as a pliers or wrench, and the retaining wire 8 is inserted into the groove. The retaining wire 8 then holds the shroud plates 3 in position until all of the blades have been installed in the stage. Then it is removed, and the shroud plate 3 is turned to final shape according to the finished contour 3.7. The retaining wire 8 can be introduced as a continuous length into the auxiliary groove, or it can be divided into sections. As an alternative to the retaining wire 8, it is also possible to use a strip of sheet metal to perform the same function.

FIG. 12 shows how, on a simple shroud plate 3 without expansion bevel, the auxiliary groove with the retaining wire 8 can be located outside the width of the blade profile 2.

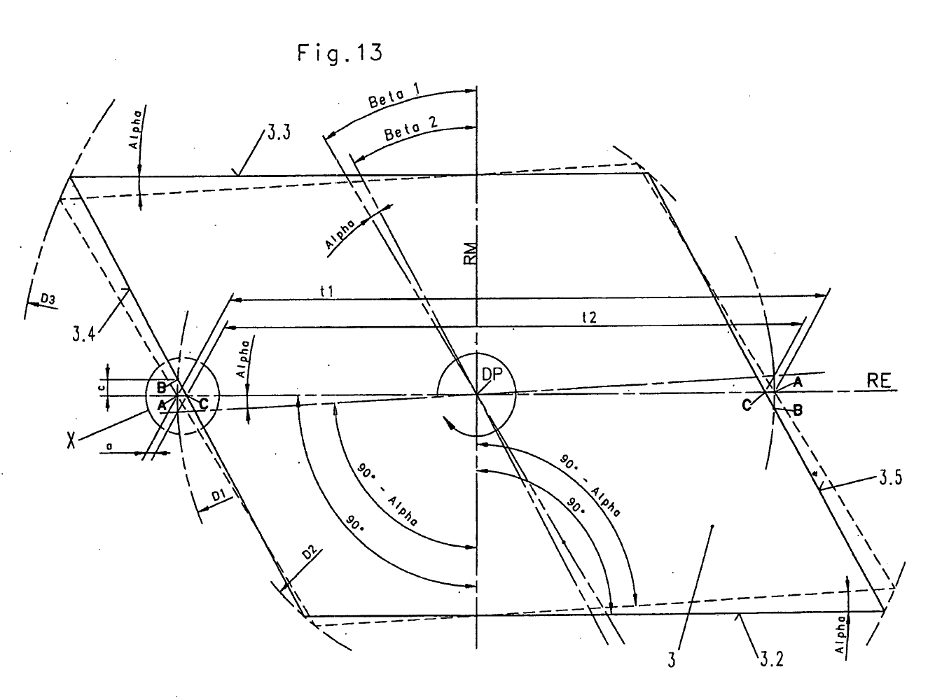

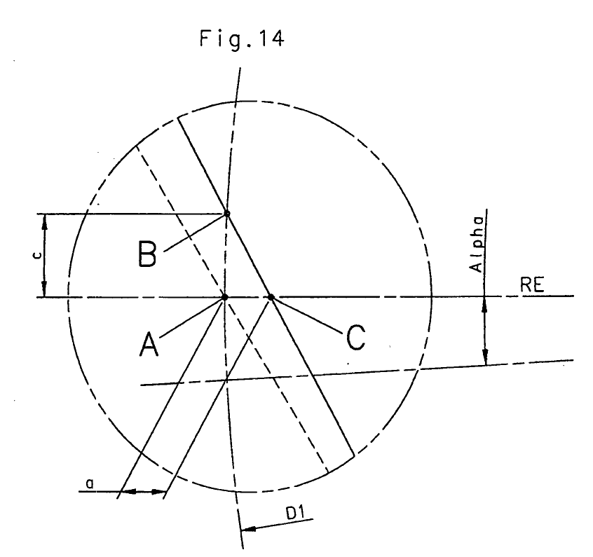

FIGS. 13 and 14 illustrate the theoretical background of the invention. FIG. 13 shows a plan view of the shroud plate 3 before and after it is twisted. Before it is twisted, the shroud plate 3 has the contour shown in broken line with the spacing “t1” from point A to A on the radial plane RE. After the shroud plate 3 is twisted by the angle Alpha, it assumes the contour shown in solid line. The spacing “t2” now lies from point C to C on the radial plane RE. The spacing “t1” has decreased by the value “a” on both sides. The rhomboid angle Beta 1 before twisting has been reduced by minus angle Alpha to Beta 2 after twisting.

The twisting of the shroud plate 3 occurs around the longitudinal axis of the blade passing through the point DP, which is located at the center of gravity of the blade profile 2. In FIG. 13, the point DP lies in the center of the shroud plate, as a result of which a symmetrical picture is obtained. If the point DP were outside the center of the shroud plate, the decreases in the spacing at the two spacing surfaces 3.4 and 3.5 would be unequal, but the sum would remain equal to that of the symmetrical design. The degree to which the spacing is decreased is independent of the position of the center of rotation DP on the shroud plate 3; this value is determined by the twist angle Alpha. When twisted, all of the points on the shroud plate 3 describe circular arcs around the point DP, such as, for example, D1, D2, and D3. Point A moves along the circular arc D1 to point B and then lies above the radial plane RE by the value “c”. The detail X in FIG. 13 is shown again in FIG. 14 on a larger scale.

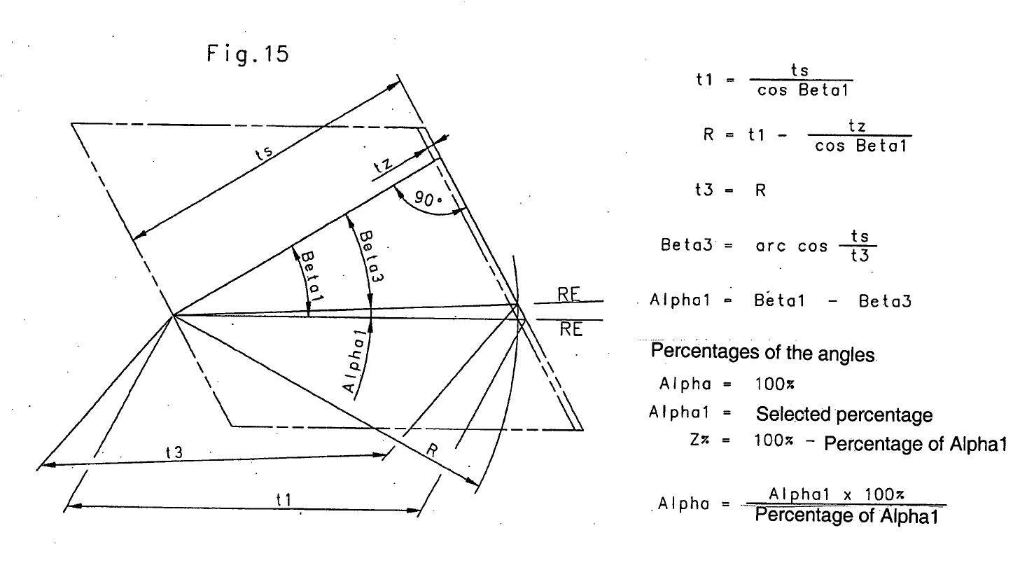

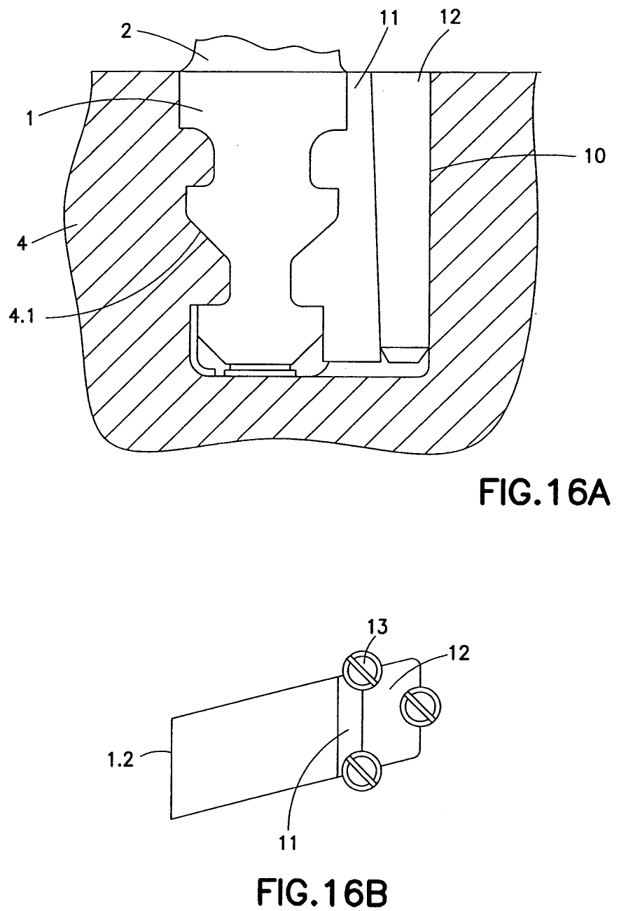

FIG. 15 shows a plan view of the shroud plate 3 and the method used to calculate the twist angle Alpha. Under the condition that the blade spacing Delta as in FIG. 2 is equal on both sides to Delta/2, the vertical spacing [ts] at the shroud plate 3 is calculated according to the following formula from the number [n] of blades installed per stage, the diameter [D max.], the rhomboid angle [Beta 1] of the shroud plate 3, and the selected spacing oversize [tz]:

$$ts = sin \frac{360 °}{n \times 2} \times D max . \times cos Beta 1 + tz$$

The parameters used in FIG. 15 have the following meanings:

t1 is the shroud plate spacing on the radial plane RE before the plates are twisted;

Beta 1 is the rhomboid angle around the center of the rotor RM before twisting (e.g., 30°);

t3=R is t1 without the spacing oversize tz (e.g., 0.2 mm) or the shroud plate spacing after twisting to tz on the radial plane RE

Alpha 1 is the theoretical twist angle for the selected spacing oversize tz (e.g., 0.36°);

Beta 3 is the rhomboid angle around the center of the rotor RM after twisting by Alpha 1;

Z % is the loss allowance added to Alpha 1; and

Alpha is the overall twist angle of the shroud plate 3, consisting of Alpha 1 and the selected loss allowance Z % (e.g., 0.6°).

FIGS. 16A shows the foot 1 of the last turbine blade inserted, i.e., the locking blade. Here a loading channel 10 has been milled as an offset in the side of the groove 4.1 in the rotor disk 4. This permits dropping the locking blade into groove 4.1 radially, whereupon a first wedge 11 with a complementary one-sided hammer head profile is emplaced, and a second wedge 12 is emplaced against the first wedge as shown. The wedges 11, 12 are then secured with grub screws 13 as shown in FIG. 16B. The loading channel 10 can also receive the other blades prior to sliding them into place in groove 4.1. After the locking blade is secured by the two-piece blade lock, the blocks 5 can be removed from the sealing combs

The invention is not limited by the embodiments described above which are presented as examples only but can be modified in various ways within the scope of protection defined by the appended patent claims.

What is claimed:

1. A turbine rotor which can rotate about a longitudinal axis, the rotor comprising:
a turbine rotor disk having at least one groove located in a radial plane which is perpendicular to a longitudinal axis; and
a row of turbine blades associated with each said groove, each said turbine blade comprising a blade foot received in the groove, a blade profile above the foot, and a shroud plate above the profile, each said blade foot and each said shroud plate having end surfaces and side surfaces which form a rhomboid, the end surfaces of each said shroud plate tapering toward each other along respective radii and abutting the end surfaces of adjacent shroud plates so that the shroud plates form a closed ring;
wherein the blade profiles are torsionally stressed by twisting the cover plates through an angle alpha so that the side surfaces of adjacent cover plates are circumferentially aligned in a plane perpendicular to the longitudinal axis.

2. The turbine rotor of claim 1 wherein each shroud plate has a spacing between end surfaces which is oversize by an offset which requires said twisting so that said shroud plates fit together to form said closed ring.

3. The turbine rotor of claim 2 wherein said offset is provided on one end of each said shroud plate.

4. The turbine rotor of claim 2 wherein said offset is provided on both ends of each said shroud plate.

5. The turbine rotor of claim 1 wherein each said shroud plate comprises a sealing comb which cooperates with a tool for twisting the shroud plate.

6. The turbine rotor of claim 1 which each said shroud plate comprises a groove which aligns with the groove in an adjacent shroud plate to receive a retaining wire when the shroud plates are twisted.

7. A method for producing a turbine rotor having a longitudinal axis, the method comprising:
providing a turbine rotor disk having at least one groove located in a radial plane which is perpendicular to a longitudinal axis; and
providing a plurality of turbine blades, each said turbine blade comprising a blade foot, a blade profile above the foot, and a shroud plate above the blade profile, each said blade foot and each said shroud plate having end surfaces and side surfaces which form a rhomboid, the end surfaces of each said shroud plate and each said foot tapering toward each other along respective radii;
inserting each said blade foot into one of said grooves so that the end surfaces of each said blade foot abut the end surfaces of adjacent blade feet and the end surfaces of each said shroud plate abut the end surfaces of adjacent shroud plates, the side surfaces of each said shroud plate forming an angle alpha with said radial plane;
applying a force acting in the direction of said longitudinal axis to each said shroud plate to twist the shroud plate through said angle alpha so that the blades are torsionally stressed and the side surfaces of adjacent cover plates are circumferentially aligned in a plane perpendicular to the longitudinal axis; and
maintaining the force on the blades until a complete circumferential row of blades has been inserted in said groove and the cover plates form a closed ring.

8. The method of claim 7 further comprising:
providing a clamping device having a longitudinal channel bounded by two sides, one of said sides having a pair of threaded bores oriented transversely to the longitudinal channel, each of said bores receiving a clamping screw;
placing said longitudinal channel over two adjacent shroud plates and centering the device between the two shroud plates; and
tightening said clamping screws against respective shroud plates to twist at least one of said shroud plates through said angle alpha.

9. The method of claim 8 wherein said longitudinal groove is received over sealing combs of adjacent shroud plates, said screws being tightened against said sealing combs.
